(19) United States
(12) Patent Application Publication
(10) Pub. No.: US 2008/0244980 A1
(43) Pub. Date: Oct. 9, 2008

(54) DRIVE ASSEMBLY FOR A CABLE WINDOW LIFT SYSTEM FOR MOTOR VEHICLES

(76) Inventor: Uwe Klippert, Rodental (DE)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/062,917

(22) Filed: Apr. 4, 2008

(30) Foreign Application Priority Data
Apr. 4, 2007 (DE) 20 2007 005 143.3

(51) Int. Cl. E05F 11/48; B66D 1/14

(52) U.S. Cl. 49/348; 254/342

(57) ABSTRACT

Drive assembly for motor vehicle cable window lift system and cable window lift system fitted with such drive assembly. The assembly may be provided with drive unit having gear housing section and rotatably mounted cable drum for winding/unwinding a system cable wherein the cable drum engages a drive unit drive gear and is coupled thereto. Cable drum is rotatably mounted shaftlessly and securing means is provided that cooperates with the cable drum to secure said drum axially and radially on the drive gear. With this secured and rotatably mounted structural design it is possible to dispense with a shaft penetrating the cable drum or a longer pivot pin. A shaftless structural design results which may be designed very flexibly compared to conventional designs. Thus, a variety of cable drums can be used to co-operate with the drive unit giving a large range of possible variations with the same drive unit.

The present patent application claims priority from German Utility Model application no. DE 20 2007 005 143 filed on 4 Apr. 2007, the whole contents of which are hereby explicitly incorporated into the present application by reference.

### FIELD OF THE INVENTION

The invention relates to a drive assembly for a cable window lift system of motor vehicles having a drive unit that has a gear housing section. Furthermore, the invention relates to a cable window lift system that is fitted with such a drive assembly. The invention refers to the earlier and already published application US 2005/0067521 A1, the whole contents of which are hereby explicitly incorporated in the present application by reference.

### BACKGROUND OF THE INVENTION

In the known drive assemblies and units for cable window lift systems for motor vehicles, a cable drum is usually provided which is mounted on a shaft in the gear housing section of the drive unit and which is driven by a drive gear that is frequently designed as a worm wheel. At least one cable for raising and lowering of the window pane is moved by way of the cable drum.

Such a drive assembly is known for example from DE 103 42 074 A1 and the corresponding US 2005/0067521 A1. In the gear unit described therein a shaft is provided in the shape of a pivot pin on which the cable drum is rotatably mounted and by way of which a worm wheel is driven. The shaft or the pivot pin is designed as part of the gearbox or gear housing and penetrates a cylindrical through opening provided in the cable drum. Depending on the field of use, the shaft may, for example, be designed as a steel axle or bolt integrally moulded to the housing, as an integral plastic shaft or even as a back-moulded metal sleeve. The shaft projecting through the cable drum may bring about especially secure mounting of the cable drum. However, if anything it is difficult with regard to the choice of material and dimensioning to make this design principle easily adaptable to many different application cases. This is because generally speaking plastic shafts are only suitable for small forces and conceal the inherent risk of a failure even during development or trial operation. The changeover to steel shafts or similar elements which may become necessary at a later stage is then rather expensive and critical in terms of time. Even the length of the shaft itself is a design parameter which has a not insignificant effect on the overall design, particularly with regard to dimensioning, which in turn restricts the scope of possible variations for different application cases and areas of use of cable window lift systems.

EP 0 360 911 B1 discloses an electric drive unit for motor vehicle cable window lift systems. In the base of the gear housing section made of plastic is embedded a steel shaft which serves to radially secure both the drive's worm wheel and also the cable drum coupled to it and which projects with a predetermined length away from the gear housing section. The cable drum is coupled to the worm wheel by way of a disc-like damping element and is pushed onto the steel bolt. The cable drum is mounted in a cup-shaped bearing cover which is fixedly connected to the drive unit. At the same time the steel bolt extends through a central hole in the bearing cover. On the front face of the cable drum directed towards the bearing cover is provided a central securing clip which is clipped into the central hole of the bearing cover so as to additionally mount the cable drum on said cover. The axial pressure thus applied to the cable drum secures it axially in the cable drum receptacle. The cable drum is radially mounted on the steel bolt. The cable drum is not secured axially directly on the worm wheel but rather by the medium of the damping disc. Overall this construction is comparatively complex as it requires a relatively large number of individual components. Due to the design of the bearing cover, the drive assembly is only suitable for mounting one type of cable drum with a predetermined height which is prescribed by the height of the cup-shaped recess in the bearing cover.

### SUMMARY OF THE INVENTION

The object of the invention is to propose a drive assembly for cable window lift systems which offers variable design possibilities in a simple and advantageous manner and thus can cover an extended range of application areas. Furthermore, a cable window lift system equipped therewith is also proposed here.

The object is achieved by a drive assembly with the features of claim 1 in addition to a cable window lift system with the features of claim 20. Further advantageous embodiments are the subject of related subclaims.

According to this, a drive assembly for a cable window lift system of motor vehicles is proposed comprising:
a drive unit having a gear housing section, and
a rotatably supported cable drum for winding and unwinding a cable of the window lift system, said cable drum engaging with a drive gear of the drive unit and being coupled with the drive gear; wherein:
the cable drum is rotatably supported in a shaftless manner; and
at least one securing means is provided that co-operates with the cable drum in order to secure said drum axially and radially on the drive gear.

The meaning of “in a shaftless manner” is to be understood to comprise all ways of mounting without using any shaft, i.e. any shaftless or shaft-free mounting of the cable drum in accordance with the present invention, e.g. as a skilled person can derive from the enclosed figures.

The drive assembly presented here is thus provided with a cable drum which engages with a drive gear, which may, for example, be a worm wheel, but is mounted shaftlessly or shaft-free wherein at least one securing means is provided that secures the cable drum axially and radially on the drive gear. As a result of this secured and rotatably mounted structural design it is possible to dispense with a shaft penetrating the cable drum or a longer pivot pin. The result is a shaftless or shaft-free structural design which may be designed very flexibly by comparison with conventional structural designs. In particular, due to the shaft-free mounting proposed here, it is possible to use a variety of different cable drums in order to co-operate with the drive unit which results in a very large range of possible variations when using the same drive unit. The structural design presented here and also its adaptation may be realised with comparative ease as a result of which the production price, amongst other things, is considerably reduced.

Especially advantageous developments of the invention emerge from the subclaims:

Accordingly, it is advantageous if the cable drum has, on a side directed away from the drive gear, a rotationally symmetrical recess or protrusion which co-operates with a correspondingly shaped protrusion or recess that is secured axially in relation to the gear housing section by way of which the cable drum can be secured axially and radially on the drive gear in a shaft-free manner. Preferably the recess is designed to be cup-shaped and the correspondingly shaped protrusion to be cylindrical. In the process, the cup-shaped protrusion may be formed or provided on a housing cover of the drive unit which is detachably joined to said drive unit. In addition it may be provided that the housing cover seals the gear housing section. As a result an efficient overall structural design of the drive unit emerges which achieves both accommodation of the drive unit itself as well as secured mounting of the cable drum in an advantageous manner.

According to a further embodiment, the cup-shaped protrusion may be formed or provided on a web or bar detachably joined to the drive unit, said web or bar diametrically bridging over or encroaching on a bearing section of the drive unit which holds the drive gear. The cup-shaped protrusion may also preferably be provided or formed on a carrier plate on which further components of a vehicle door, for example operating elements, side airbag module, window lift rail, are mounted or may be mounted. The carrier plate including the cup-shaped protrusion may at the same time be formed from a metal sheet, for example using the punching/stamping technique, or from a plastic, in particular by injection moulding.

According to a further embodiment, the rotationally symmetrical recess may be formed in the cable drum wherein a securing element, secured axially in relation to the drive unit and shaped correspondingly to said recess engages in the recess in order to secure the cable drum axially and radially on the drive gear. In the process, the securing element may be provided or formed on a housing cover or a carrier plate which is joined to the drive unit. In particular, the securing element may be attached to or cast onto a housing cover or the carrier plate, for example as a rivet or a bolt.

It is also possible to provide preferably at least one additional securing means which latches or locks the cable drum to the drive gear such that said drum is secured axially and radially on said drive gear. Thus for assembly the cable drum need only be pushed onto the drive gear, as a result of which axial securing is brought about automatically by latching or locking of said cable drum. In connection with this it is advantageous if the relevant additional securing means is formed integrally with the cable drum and/or the drive gear. Moreover, it is advantageous if the relevant additional securing means is designed as a clip connection, click connection or snap lock.

According to a further embodiment, the drive gear is completely accommodated in a sealed manner in a receptacle formed in the gear housing section, on the bottom of which a shaft mounting the drive gear only is provided or formed. It may also be advantageous if a front, free end of the shaft does not project above an upper edge of the receptacle. In such an embodiment, a circumferential seal for sealing the gear housing section may simply be fitted on the upper edge thereof or may be formed on said edge. In connection with this, a cylindrical section, the external diameter of which is smaller than the external diameter of the shaft, is also preferably provided on the front, free end of said shaft in order to make installation of the drive in the receptacle easier. Furthermore, the cable drum may also be completely covered by the shaft in an advantageous manner.

### OVERVIEW OF FIGURES

The invention and the advantages arising therefrom will be described in greater detail in the following on the basis of embodiments wherein reference will be made to the associated drawings:

FIG. 1 shows a first embodiment with a shaftlessly mounted cable drum.

FIG. 2 shows a second embodiment with a protrusion engaging in the cable drum as a securing means.

FIG. 3 shows a variation on the embodiment according to FIG. 2.

### DETAILED DESCRIPTION OF PREFERRED EMBODIMENTS

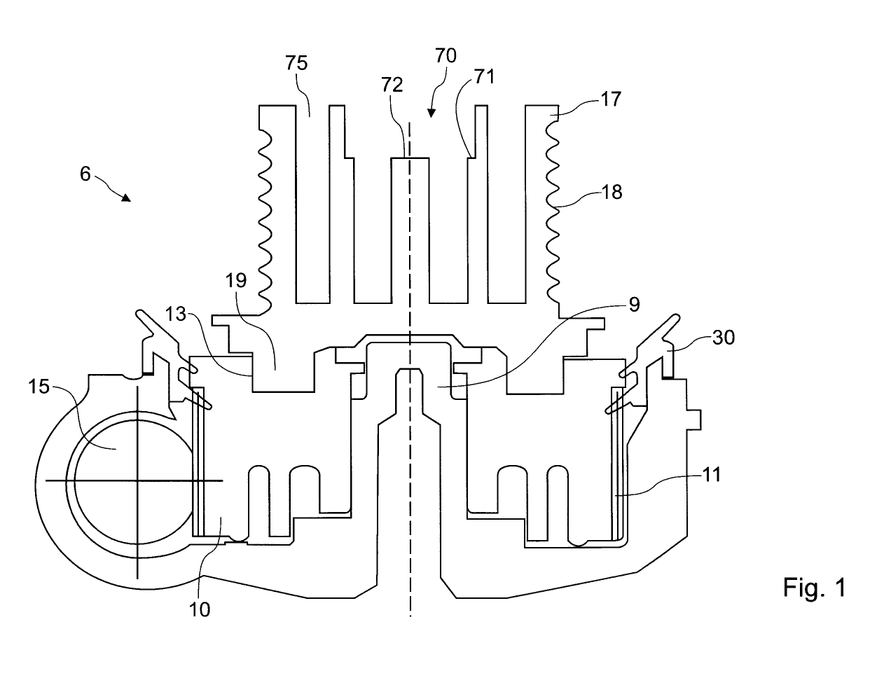

FIG. 1 shows a gear housing section 6 in a drive assembly for a cable window lift system of motor vehicles. Gear housing section 6 illustrated here in cross-section is part of the drive unit for the cable window lift system. Connected to gear housing section 6 is a cable drum 17 which is rotatably mounted for winding and unwinding a cable of a window lift system. The cable drum engages in or is linked to a drive gear 10, designed here as a worm wheel. Worm wheel 10 is located in turn in gear housing unit 6 and is driven via a gear toothing 10 by a drive wheel or a drive worm 15. Drive worm 15 sits on a motor shaft, not illustrated, of an electric motor which is electrically controlled for driving the cable window lift system.

Inside gear housing section 6 worm wheel 10 is rotatably mounted on a shaft 9 wherein shaft 9 according to the invention is designed to be so short that it does not project or projects only slightly out of worm wheel 10. Cable drum 17 coupled to gear wheel 10 is not penetrated by this shaft but is rotatably mounted so as to be shaftless or shaft-free. To secure the cable drum in both the axial and the radial direction at least one securing means is provided, here for example, an engagement executed as clip connection 19 which connects cable drum 17 to worm wheel 10. The securing means executed as clip connection 19 engage in the corresponding receivers on worm wheel 10. As a result cable drum 17 becomes fixedly and yet re-detachably connected to worm wheel 10 and in fact such that cable drum 17 is fixed without play in the axial and the radial direction at least. In the circumferential direction on the other hand, cable drum 17 can definitely illustrate a certain elastic play which has a damping effect when starting up or slowing down cable drum 17.

FIG. 1 thus shows a drive assembly for a cable window lift system of motor vehicles with a drive unit having a gear housing section 6 with a cable drum 17 for winding and unwinding a cable of the window lift, wherein cable drum 17 is coupled to a drive gear 10 of the drive assembly and is mounted in gear housing section 6. Cable drum 17 is at least due to a securing means 19, especially due to an engagement of cable drum 17 in the drive gear or worm wheel 10, rotatably mounted to be shaftless or shaft-free and is axially and radially secured in the drive assembly. At the same time the at least one engagement 19 may be designed as a securing means, for example in the shape of a clip connection, click connection or snap lock, which connects cable drum 17 to worm wheel 10 in a form-fitting and/or force-fitting manner.

It is achieved by means of the structural design shown in FIG. 1 that cable drum 17 is flanged onto gear housing section 6 shaftlessly or shaft-free and is secured both axially and radially. Due to the fact that no rotary shaft penetrates the cable drum, the structural design is flexible, especially in respect of the execution or design of cable drum 17 used, especially in respect of its height. Thus one and the same gear housing section 6 or gear housing section may be fitted with differently designed cable drums, especially cable drums of different heights, without having to allow for an existing rotary shaft. Thus the structural design is very variable and flexible especially with regard to its total height.

Gear housing section 6 or the gearbox section may preferably be provided with a short plastic shaft 9. This shaft 9 then essentially supports only worm wheel 10.

For further securing of cable drum 17, according to FIG. 1 a cup-shaped protrusion 70 designed as a securing means is provided, which is shaped rotationally symmetrically and which may serve to hold a thrust bearing. This thrust bearing co-operates in a form-fitting manner with the cup-shaped protrusion in order to secure the cable drum radially. At the same time the thrust bearing is axially fixed in relation to the gear housing section such that it is also possible to achieve axial securing of cable drum 17. As a result, cable drum 17 according to the invention is secured both on the motor side by means of securing means 19 located there as well as on the side directed towards the window lift by means of correspondingly shaped cup-shaped protrusion 70 located there as a securing means. Cup-shaped protrusion 70 has in particular a limit stop 72 which secures in the axial direction in addition to lateral cylindrical guides 71 which secure in the radial direction.

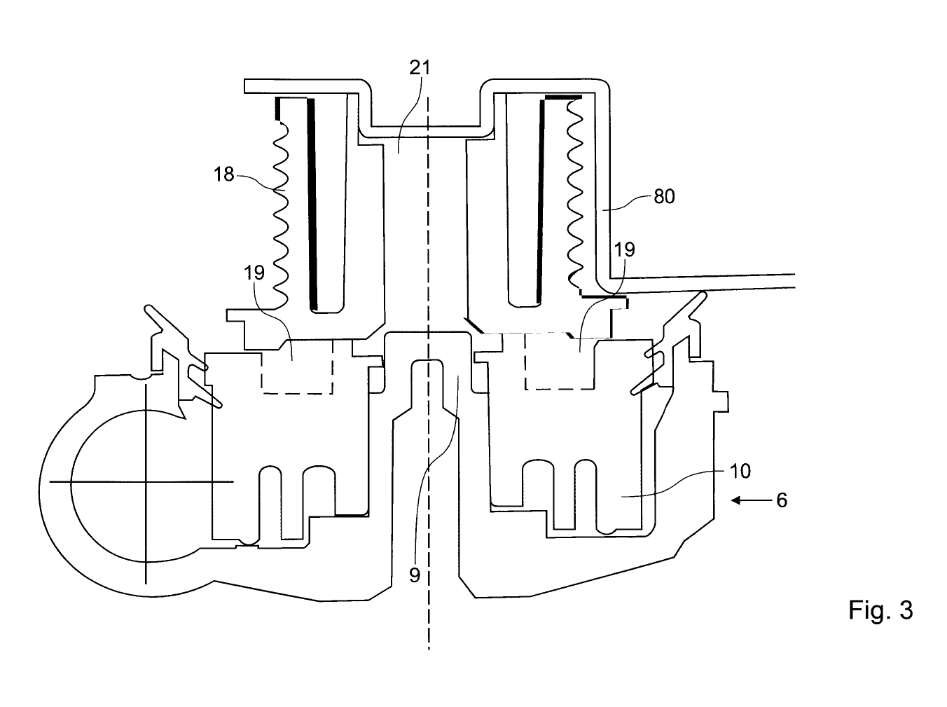

By means of this shaftless structural design, not merely the design of the whole drive unit or of gear housing section 6 is variable but also the design of cable drum 17 itself. As FIG. 1 shows, it is possible, for example, to provide in cable drum 17 one or a plurality of hollow spaces 75 at almost any point and especially also in the centre of cable drum 17 which serve to reduce weight or save material. It is possible on the other hand to dispense with a bushing for a rotary shaft. Nevertheless, cable drums with cylindrical through opening may also be used (cf. FIG. 3). Or even integral cable drums consisting of solid material may be used.

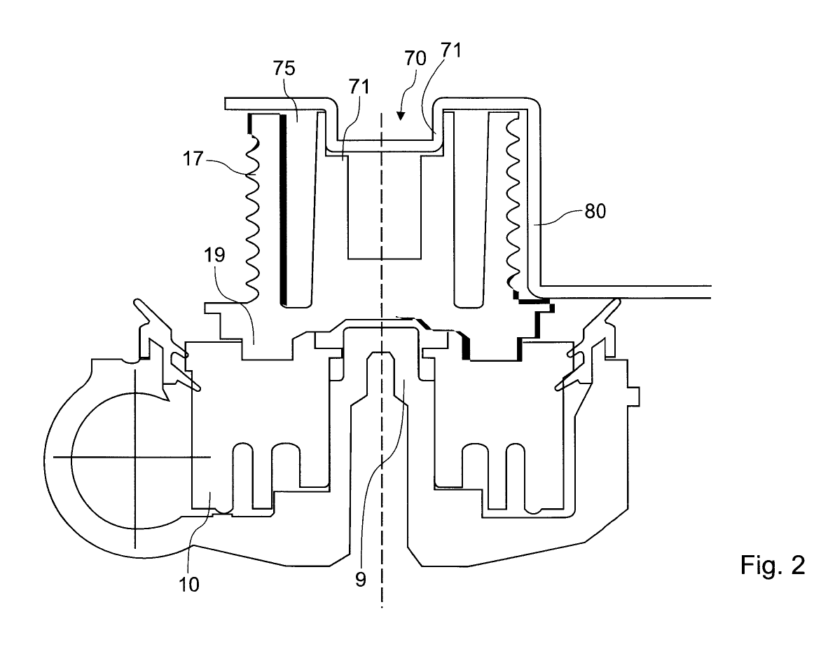

FIG. 2 shows a further embodiment of the invention in which cable drum 17 at its upper end, that is to say towards the window lift, has a thrust bearing designed as an axial and radial securing device. The thrust bearing consists essentially of a cup-shaped protrusion 70 formed on cable drum 17 and a protrusion 81 corresponding thereto which is part of a support or a carrier plate 80. Protrusion 81 may be formed, for example, in the housing cover of the drive unit or in a web or bar which encroaches diametrically on a gearhousing section supporting the drive gear. Alternatively, carrier plate 80 may serve as a base plate on which even further components, such as operating elements, side airbag module, window lift rail, etc. are mounted. Alternatively to protrusion 81 illustrated, a rivet or bolt designed as a securing element may also be provided on the base plate. The structural design illustrated in FIG. 2 shows an especially secure bilateral mounting of cable drum 17, that is to say a mounting with securing in the bottom region on the engine side by means of a form-fit, especially by means of clip connection 19, and in the top region on the opposing side by means of a friction or thrust bearing which is formed, for example, from recess 70 and protrusion 81 co-operating therewith. Preferably, carrier plate 80 or the base plate terminates so as to seal gear section 6. For this an appropriate circumferential seal 30 is provided which is fitted on the upper edge of the gear housing section or may be formed thereon, especially injection moulded, in order to seal the gear housing section with the drive gear mounted inside it.

FIG. 3 illustrates an alternative structural design to FIG. 2 wherein cable drum 17 has a cylindrical through opening 21 through which a rotary shaft may be guided. However, even with this structural design, a short shaft 9 or a short or stub shaft is provided such that cable drum 17 is shaftlessly mounted in this case also. Cable drum 17 illustrated has the advantage, however, that it can also be used in a conventional system or in a conventional drive assembly with penetrating rotary shaft.

As in the previous embodiments, however, here too in the embodiment according to FIG. 3, gear housing 6 is provided with a short plastic shaft 9. Thus shaft 9 then essentially supports worm wheel 10 only. Cable drum 17 is also mounted here by way of the interface toothing on the motor side and by way of a pot in the base plate on the side directed towards the window lift. Alternatively, a nozzle or even an extra part, such as a rivet or a bolt for example, may be used in the base plate. The mounting may be integrally moulded on in the case of a plastic bearing cover.

As may be seen in all the FIGS., a centering device for cable drum 17 is provided on the free end of shaft 9 or the shaft stub. This is achieved by means of a graduation of the shaft stub. Worm wheel 10 may completely cover shaft stub 9. In this case the additional seal in this region may be dispensed with. Drive shaft 9 no longer protrudes into the window lift and also does not produce any new motor variant. Likewise, the use of a sheet metal sleeve may be dispensed with completely which also leads to a reduction in cost of the motor.

The following procedure is followed for installing a drive assembly according to the invention (cf. FIGS. 1 to 3): first of all the drive unit is formed with gear housing section 6 provided therein, preferably by injection moulding of a suitable plastic material. According to FIGS. 1 to 3, shaft 9 does not in this case project above the upper edge of gear housing section 6. Subsequently, the electric motor with associated control electronics (not shown) is inserted and then drive gear 10, especially a worm wheel, is inserted into gear housing section 6. Finally, circumferential seal 30 is placed on the upper edge of gear housing section 6 in order to seal it towards the outside. Alternatively, the seal may already have been placed on the upper edge of gear housing section 6 and the drive gear may be inserted into gear housing section 6.

Then cable drum 17 is coupled to drive gear 10 by means of a form-fitting engagement by way of claws or similar as disclosed by way of example in DE 103 42 074 A1 the contents of which are explicitly incorporated herein by way of reference for the purposes of disclosure. In this condition cable drum 17 is not yet secured axially and radially on the drive gear. Then cable drum 17 is wound with the cable and coupled to the cable window lift system (not shown).

Subsequently, the thrust bearing previously referred to is formed on drive gear 10 for securing cable drum 17 axially and radially. According to a first variation, for this purpose a bearing cover is placed on gear housing section 6 and fixedly joined to the drive unit such that said housing section is secured axially on the drive unit. As described previously, a protrusion or a projection, which is formed or provided on the bearing housing, co-operates with cup-shaped recess 70 or with the projection of cable drum 17 in such a manner that cable drum 17 is secured axially and radially on drive gear 10. By means of the thrust bearing thus formed, drive gear 10 is also secured axially on shaft 9 at the same time. Lateral cylindrical through openings are formed in the bearing cover for pushing the cable through from the cable drum receptacle thus formed. The bearing cover need not necessarily be designed as closed at all but may by way of comparison be designed as open. As described above, instead of such a bearing cover a web or bar may serve as the thrust bearing which is attached on the drive unit and encroaches diametrically on gear housing section 6 and cable drum 17 coupled to drive gear 10 in order to mutually secure drive gear 10 and cable drum 17 axially and in order at the same time to ensure that cable drum 17 is axially and radially secured in relation to drive gear 10. In this case, provided on the web or bar is a recess or a protrusion which co-operates with correspondingly formed cup-shaped recess 70 or a corresponding projection of cable drum 17 in order to form the thrust bearing.

Finally, the drive assembly thus assembled is installed in the vehicle door. To do this the drive assembly may be installed in the known manner on a carrier plate or a door module member and these are then inserted into an installation aperture of the vehicle door.

As described above, according to the invention, basically a carrier plate or a door module member may co-operate with cable drum 17 in order to form the thrust bearing in the manner previously described. Thus for installation in the case of such an embodiment, the drive unit with the cable drum attached is placed axially on the carrier plate or door module member and finally the drive unit is joined to the carrier plate or the door module member. Finally, the carrier plate or the door module member is inserted into the installation aperture of the vehicle door. So that drive gear 10 does not accidentally fall out of the drive unit during pre-assembly, a circumferential rib or a comparable securing means, which the drive gear is clipped onto, may be provided on shaft 9 to act as a captive securing means to prevent loss. So that cable drum 17 does not accidentally separate from drive gear 10 during pre-assembly, additional securing means, which are provided in the engagement region between cable drum 17 and drive gear 10, may secure cable drum 17 in relation to drive gear 10. For this purpose, the additional securing means may be designed as clips, latching elements or similar. These may basically be formed integrally with cable drum 17 and/or drive gear 10, especially on engagement claws or the like formed thereon, but may also, however, be used as additional securing elements in the engagement region.

As will be easily be obvious to the person of average skill in the art, the drive assembly according to the invention is also basically suitable in a corresponding manner for manually adjustable cable window lift systems of motor vehicles.

The description provided above is directed at particularly preferred embodiments of the invention. The object defined according to the claims nevertheless covers the numerous variations and modifications of the invention.

### LIST OF REFERENCE NUMBERS

6 Gearbox section/gear housing section
9 Shaft/shaft stub
10 Drive gear/worm wheel
11 Gear toothing
15 Drive worm
17 Cable drum
18 Guide grooves
19 Clip connection as securing means
21 Cylindrical through opening
30 Seal
70 Cup-shaped recess as securing means
71 Lateral guide
72 Stop/shoulder
75 Hollow spaces to reduce weight and save material
80 Carrier plate
81 Protrusion, corresponding to cup-shaped recess 70

1. A drive assembly for a cable window lift system of motor vehicles, said drive assembly comprising:
a drive unit having a gear housing section, and
a rotatably supported cable drum for winding and unwinding a cable of the window lift system, said cable drum engaging with a drive gear of the drive unit and being coupled with the drive gear; wherein:
the cable drum is rotatably supported in a shaftless manner; and
at least one securing means is provided that co-operates with the cable drum in order to secure said drum axially and radially on the drive gear.

2. The drive assembly as claimed in claim 1, wherein the cable drum has, on a side directed away from the drive gear, a rotationally symmetrical recess or protrusion, acting as a securing means, which co-operates with a correspondingly shaped protrusion or recess that is secured axially in relation to the gear housing section in order to secure the cable drum axially and radially on the drive gear.

3. The drive assembly as claimed in claim 2, wherein the recess is cup-shaped and the correspondingly shaped protrusion is cylindrical.

4. The drive assembly as claimed in claim 3, wherein the cylindrical protrusion or recess is provided or formed on a carrier plate, on which further components of a vehicle door are mounted or may be mounted.

5. The drive assembly as claimed in claim 3, wherein the cylindrical protrusion or recess is formed or provided on a housing cover of the drive unit which is detachably mounted to said drive unit.

6. The drive assembly as claimed in claim 5, wherein the housing cover seals the gear housing section.

7. The drive assembly as claimed in claim 3, wherein the cylindrical protrusion or recess is formed or provided on a web detachably joined to the drive unit, said web diametrically bridges over a bearing section of the drive unit which holds the drive gear.

8. The drive assembly as claimed in one of claim 2, wherein the rotationally symmetrical recess or protrusion is formed in the cable drum wherein a securing means or element, secured axially in relation to the drive unit and shaped correspondingly to said recess or protrusion, engages in the recess or protrusion in order to secure the cable drum axially and radially on the drive gear.

9. The drive assembly as claimed in claim 8, wherein the securing means or element is provided on a housing cover or a carrier plate which is mounted to the drive unit.

10. The drive assembly as claimed in claim 9, wherein the securing means or element is fixed or cast onto a housing cover or on the carrier plate.

11. The drive assembly as claimed in claim 10, wherein the securing element is a rivet or a bolt.

12. The drive assembly as claimed in claim 1, wherein at least one additional securing means is provided which latches or locks the cable drum to the drive gear such that said cable drum is secured axially and radially on said drive gear.

13. The drive assembly as claimed in claim 12, wherein the respective additional securing means is formed integrally with at least one of the cable drum and the drive gear.

14. The drive assembly as claimed in claim 12, wherein the respective additional securing means comprises a clip connection, click connection or snap lock.

15. The drive assembly as claimed in claim 1, wherein the drive gear is completely accommodated in a sealed manner in a receptacle formed in the gear housing section on the bottom of which a shaft is provided or formed, said shaft supporting only the drive gear.

16. The drive assembly as claimed in claim 15, wherein a top, free end of the shaft does not protrude beyond an upper edge of the receptacle.

17. The drive assembly as claimed in claim 16, wherein a cylindrical section is provided on the top, free end of said shaft, and wherein the external diameter of said cylindrical section is smaller than the external diameter of the shaft in order to ease mounting of the drive in the receptacle.

18. The drive assembly as claimed in claim 1, wherein the cable drum completely covers the shaft.

19. The drive assembly as claimed in claim 4, wherein at least one of operating elements, side airbag module or window lift rail are mountable on the carrier plate.

20. A cable window lift system for a motor vehicle having a drive assembly, said drive assembly comprising:
a drive unit having a gear housing section, and
a rotatably supported cable drum for winding and unwinding a cable of the window lift system, said cable drum engaging with a drive gear of the drive unit and being coupled with the drive gear; wherein:
the cable drum is rotatably supported in a shaftless manner; and
at least one securing means is provided that co-operates with the cable drum in order to secure said drum axially and radially on the drive gear.
